(19) United States
(12) Patent Application Publication
(10) Pub. No.: US 2016/0092902 A1
(43) Pub. Date: Mar. 31, 2016

(54) Distributed Offer Marketing Over Network System and Method

(71) Applicant: Beanstream Internet Commerce, Inc., Victoria (CA)

(72) Inventor: Grant Dylan Storry, Victoria (CA)

(73) Assignee: Beanstream Internet Commerce, Inc., Victoria (CA)

(21) Appl. No.: 14/862,201

(22) Filed: Sep. 23, 2015

Related U.S. Application Data
(60) Provisional application No. 62/057,114, filed on Sep. 29, 2014.

(51) Int. Cl. G06Q 30/02; G06Q 30/06; G06Q 20/38

(52) U.S. Cl. CPC G06Q 30/0225; G06Q 20/387; G06Q 30/0248; G06Q 30/0226; G06Q 30/0633

(57) ABSTRACT

An actor creates marketing offers in an offer and redemption system. On checkout at the merchant store or website, a customer's payment method is tokenized and associated with a purchase transaction, the system produces a unique code on the receipt. A customer can create a unique profile ID and customer profile and associate past transactions associated with the tokenized payment method by entering a unique code off any receipt where that payment method was used in the transaction. An actor can utilize the system to create marketing offers based off of purchase behavior and attach those offers to a unique customer profile ID. Offers are associated with the unique profile ID and are delivered to the customer. Rewards can also be automatically redeemed when conditions of the offer are met. Customers may add multiple payment methods to the profile. Subsequent use of any of the payment methods in the profile will automatically associate qualifying purchase behavior, eligible offers, and reward redemption with the customer's profile. The payment system interacts with the offer and redemption module or system to provide the offer and profile information to the customer, and to report and track offers and redemptions, providing a full circle, closed loop accounting for the merchant and other actors.

This application claims the benefit of U.S. Provisional Patent Application No. 62/057,114, filed on 29 Sep. 2014 and titled “Mobile Commerce System and Method,” which is incorporated herein by reference in its entirety.

### FIELD OF THE INVENTION

The present invention relates to ecommerce, and more particularly, relates to a mobile ecommerce promotional marketing offer and redemption system and method for developing and managing mobile commerce among merchants, co-merchants, developers and customers in network-connected environment such as the Internet or other type of network.

### BACKGROUND OF THE INVENTION

Retail consumers' expectations are shifting dramatically. Consumers want compelling in-store technology, individualized offers, enhanced consistent experience across devices, and improved mobile shopping options. However, marketing vendors, merchants, and consumers all face various challenges with loyalty reward programs, marketing offers and the like. For example, marketing software vendors or services offering coupons and offers to their clients (the merchant) lack insight into whether their offers are having the desired effect in driving specific purchase behaviors. Merchants can't easily create local marketing campaigns to refer customers to complimentary businesses and have those businesses refer customers back to them. Training staff on redemption procedures is a burden that merchants would like to avoid. Further, it is very difficult for the merchant to measure the effectiveness of a campaign. Tracking offers and redemptions are difficult and labor intensive, and analyzing effectiveness is impossible without good tracking. Customers want a good deal and want to redeem their loyalty or reward program offers or rewards, but, they may easily forget which loyalty programs they are enrolled in and how to accrue rewards, forget or lose their physical loyalty cards or coupons, or become frustrated with complicated processes to redeem rewards.

Loyalty programs themselves may suffer from a variety of challenges. The majority of loyalty cards are never activated. For those that are, determining whether a merchant has achieved customer loyalty through their use is almost impossible without proper data collection and integration. Further, some speculate that it is the customer experience of the merchant's products and services that drive customer loyalty, not just the savings provided by a loyalty program. This makes the handling of loyalty programs by merchants, providing a superior, delightful experience for the customer, more important than ever. Accordingly, a need exists for an improved system and methods for managing customer loyalty programs. The present invention provides a solution to these needs and other problems, and offers other advantages over the prior art.

### SUMMARY OF THE INVENTION

In an ecommerce environment, payments are a foundational part of what consumers are looking for from their ecommerce experience, but they are looking beyond payments for special offers, loyalty programs and a better shopping experience. Specifically, consumers are asking for meaningful marketing, in the form of loyalty, gift cards, and coupons, delivered to their mobile devices. Customers do not want to have to remember to bring a coupon or loyalty card with them at all times, but want to ensure that they receive their loyalty rewards.

Merchants are looking for ways to not only increase effectiveness of their loyalty campaigns, but to be able to view and analyze the results without a lot of manual labor. Merchants often contract with third parties to implement loyalty/reward programs. Previously, implementation of these programs was disjointed and labor intensive as the systems were not integrated with the payment platforms and the merchant typically had to manually enter data and reconcile rewards within the third party's system. Transactions created in physical stores were separate from transactions created online. Distributing Offer Marketing (Distributed Offers), as described herein, solves these problems and provides a system and method for closing the loop on offer redemption. It also offers an open platform so that third party software vendors can connect to merchants in a “many-to-many” model. For example, many software vendors may connect to many merchants in the network through one integration.

Distributed offer marketing may be described in terms of two major sets of services: (1) a dynamic customer profiler creating a tokenized identifier for the customer's payment method and type and (2) distributed offers. The dynamic customer profiler generally functions by collecting information from a customer's credit or debit card, generating a token on the payment method associated with the customer's transaction, creating a unique customer identifier (ID) and gathering, storing and distributing tokenized payment type along with the ID. Merchant-created offers are linked to tokens for automatic and seamless redemption. Merchants may create co-promotional campaigns and referral campaigns with other merchants across a network.

Distributed offers marketing provides application developers with open and scalable APIs allowing for full cycle offer accounting of customer reward or loyalty programs. Developers may have a way for their marketing campaign applications to track offer redemption on client (merchant) third party systems. Distributed offers provides the method to support tracking offers using API integration rather than manual workarounds. These functions may be implemented or operated the separate individual computer systems or individual applications on one system that interact with each other. The functions also may be implemented differently upon merchants, customers and developers environments, however, the point of sale and payment stream is the perfect place to close the loop on revenue generated by offers. By opening up the payment stream on a purchase that is associated with an offer code, third parties other than the consumer and merchant can track purchase behavior and update their systems to understand how effective various marketing programs have been at driving real revenue.

One of ordinary skill in the art will understand that positive network effects are created for merchants adopting the disclosed system and method whereby they can create referral campaigns with their peers and take advantage of marketing apps that utilize the technology to give them granular ROI on marketing spend. Linking offers to pay types allows redemption to happen seamlessly behind the scenes, providing a superior experience for both the merchant and then customer.

In one embodiment of the disclosed invention, a system is provided for creating loyalty offers and redemption services over a network. Such a system may receive a merchant opt-in for access to a loyalty offer and redemption service, wherein access allows the merchant to (i) configure loyalty campaigns as offers to a customer at a merchant store or website wherein the campaign is defined for a product or service, (ii) identify as a member of a merchant network and (iii) allow the merchant to locate a second merchant who is a member of the merchant's network and propose and activate a co-promotional campaign. The system further receives a payment transaction comprising customer and payment details, including payment type and identifier, wherein the payment transaction is the result of a customer purchase at the merchant store or web site and generates a token id from the customer's payment method. When the customer makes a subsequent purchase, the payment type is tokenized and the system checks to see if there is a match to any previously activated profile IDs. If there is a match, the system then checks to see if there are any offers attached to the profile ID and if there is, the customer is presented with an opportunity to redeem them.

In another embodiment of distributed offers marketing over network, a computer program product is provided for providing loyalty offer and redemption services to customers of merchant stores. Such a computer program product comprises a non-transitory computer readable medium having computer readable program instructions stored therein, wherein said computer readable program instructions comprise: (1) instructions configured to receive a merchant opt-in for access to a loyalty offer and redemption service, wherein access allows the merchant to (i) identify as a member of a merchant network and (ii) configure loyalty campaigns as offers to a customer at a merchant store or website wherein the campaign is defined for a product or service and (iii) allow the merchant to locate a second merchant who is a member of the merchant's network and propose and activate a co-promotional campaign; and instructions configured to receive a payment transaction comprising customer and payment details, including payment type and identifier, wherein the payment transaction is the result of a customer purchase at the merchant store or web site and at least generate a token id from the customer's payment method, determine the eligible offers available for the transaction based on the transaction details and associating the offer with the token id. Further, instructions configured to receive a subsequent payment transaction identified by the token id created from the customer's payment method wherein the payment transaction is the result of a customer purchase at (i) the first merchant store or website or (ii) a second merchant store or website associated with the first merchant store and a co-promotional campaign; instructions configured to match the token id created from the customer's payment method to activated promotional campaigns to locate available offers; instructions configured to automatically redeem eligible campaign offers based on the token id created from the customer's payment method; and instructions configured to record the offer and redemption details by token id created from the customer's payment method, the record comprising at least purchase and cart data and revenue.

In another embodiment of distributed offers marketing over network, a computer-implemented method is described, which provides a computing system comprising a computing processing device and a non-transitory computer readable medium, where the computer readable medium comprises configured computer program instruction code, such that when said instruction code is operated by said computer processing device, said computer processing device performs the following operations of (1) receiving a merchant opt-in for access to a loyalty offer and redemption service, wherein access allows the merchant to identify as a member of a merchant network and configure loyalty campaigns as offers to a customer at a merchant store or website; receiving a payment transaction comprising customer and payment details, wherein the payment transaction is the result of a customer purchase at the merchant store or web site; generating a customer profile based on the customer's payment information, wherein creation of the customer profile includes generation of a tokenized version of the received payment method; providing the generated unique identifier to the customer; receiving, from the customer, an enrollment request containing the unique identifier comprising the tokenized version of the received payment method, such that the customer is enrolled in the loyalty offer and redemption service; identifying and providing merchant offers available to the customer, the offers linked to the tokenized payment method unique identifier; automatically redeeming the offer at the point of sale; and sending real time notifications to the merchant and the redemption service that the offer has been redeemed including transactional details comprising the customer's payment method token id, purchase and cart data and revenue.

In addition, the computer implemented method described also involves receiving additional payment transactions for the customer, wherein the payment transactions are the result of purchases from the same or a different merchant and linking the new payment methods to the customer account. The method may further tokenize the additional payment methods for association with the customer profile and original tokenized payment method identifying the account such that the customer may pay with any of the payments within the profile and receive their loyalty offers and rewards by virtue of the association between tokenized payment methods.

The distributed offer marketing over network system, method and computer program product described herein offers significant improvements over the prior art in this area and offers other benefits which will become apparent throughout the disclosure.

### DESCRIPTION OF THE DRAWINGS

FIG. 1 is illustrates an exemplary conceptual diagram of a mobile POS platform and its environment in practicing present invention;

FIG. 2 is a block diagram illustrating an exemplary mobile platform architecture upon which embodiments of the present invention may be implemented;

FIG. 3 is a block diagram illustrating an exemplary flow for a merchant to enroll the services of the distributed offer marketing system and methods;

FIG. 4 is an exemplary screenshot of a merchant dashboard in accordance with an embodiment of the present invention;

FIG. 5 is an exemplary user interface for viewing a merchants distributed offer marketing and payment processing apps in accordance with an embodiment of the present invention;

FIG. 6 is a block diagram illustrating of creating and configuring a merchant app in accordance with an embodiment of the present invention;

FIG. 7 is an exemplary user interface depicting a merchant dashboard and viewing campaigns in accordance with one embodiment of the present invention;

FIG. 8 is an exemplary user interface depicting new campaign configuration on a merchant dashboard;

FIG. 9 is a block diagram illustrating an exemplary flow for setting up a co-promotional campaign in a merchant dashboard;

FIG. 10 is a conceptual block diagram illustrating the interaction of the several layers of modules in accordance with an embodiment of the present invention;

FIG. 11 is a block diagram illustrating an exemplary flow of customer checkout and accumulation of rewards prior to redemption of rewards according to an embodiment of the present invention;

FIG. 12 is a block diagram illustrating an exemplary flow for customer checkout and redemption of rewards, including a query for available co-promotions according to an embodiment of the present invention;

FIG. 13 illustrates a conceptual flow of notification APIs between the merchant and payment and redemption services when a distributed offer marketing campaign is created;

FIG. 14 illustrates a conceptual flow of notification APIs between the merchant and payment and redemption services when a customer makes a purchase of offer-eligible products or services;

FIG. 15 illustrates a conceptual flow of notification APIs between the merchant and payment and redemption services when a customer makes a purchase of redemption-eligible products or services.

One skilled in the art will readily recognize that the above figures are examples and that other architectures, modes of operations, orders of operation and elements/functions can be provided and implemented without departing from the characteristics and features of the invention, as set forth in the claims.

### DETAILED DESCRIPTION

The disclosed embodiments are described below with reference to the accompanying drawings, in which some, but not all, embodiments of the inventive concept are shown. The invention may be embodied in many different forms and should not be construed as limited to the embodiments described herein. The embodiments described are offered by way of example and not limitation. The claims describe the metes and bounds of the invention. Like numbers refer to like elements throughout.

The present disclosure describes various embodiments of a method, system and computer program product for providing payment transactions and reward or loyalty offer redemption services across merchants, pay types and channels. An omni-channel (i.e. mobile, web, and retail brick-and-mortar sales channels) mobile Point of Sale (mPOS) payment platform receives a transaction from a participating merchant, tokenizes the payment method for private storage and subsequent use, builds a customer profile based off a customer's payment type token details (generally derived from a card's EMV chip, card PAN and token) and provides a mechanism for the customer to claim the profile through a unique code. Once the profile is claimed by the customer, the customer can round out their profile with payment details, all of which may be tokenized and synched with future tokenized payment methods that are subsequently added. The data from that profile synchs with future tokenized payment methods such that the profile becomes the master. The profile may be used as an mPOS checkout solution across channels for merchants associated with the payment platform. Distributed Offers can be attached, or linked, to the profile and redemption of offers can be facilitated through the use of any pay type associated with the customer's profile. When the customer is ready to check-out, they can simply tap, swipe or insert their card and the payment type is connected with their profile. The system may scan the profile to see if there are any offers eligible for redemption linked to the profile ID and presents those offers to the user, or the system, to redeem. If redeemed, the transaction amount is modified accordingly and a notification is triggered in Distributed Offers. The notification invalidates the offer as redeemed and sends a notification to the party who created the offer so they can close the loop on reporting. In some embodiments, a third party may act as the loyalty redemption service by creating campaigns from merchant configuration, tracking purchases and customer eligibility for loyalty programs, obtaining an offer code for eligible transactions, unlocking a reward for redemption and reconciling loyalty program accounting.

The described Distributed Offer system, method and computer program product provides a unique set of features not previously available to small and medium sized businesses. Distributed Offers: (1) allow merchants to create local marketing campaigns to refer customers to complimentary businesses and measure the effectiveness of their campaign without manual accounting; (2) allow a marketing vendor to understand if and how the coupons and offers supplied to a merchant's customers are having the desired effect in driving specific purchase behavior, by offering end to end closed loop reporting on how well offers generated by the merchant performs to increase merchant revenue; and (3) provides automatic rewards redemption at the payment terminal without the use of physical coupons, loyalty cards, etc. at physical stores, or the collection of promotional codes or the like on website checkout pages. To accomplish this, Distributed Offers simply attaches the offer to the customer's payment method or profile so that it may be redeemed at the point of sale simply by using the credit or debit card to which the offer is attached (or one that the customer has associated it with in his or her profile) during the checkout process, creating a seamless redemption process driven by the Point-of-sale system (mPOS). The point of sale and payment stream, which contains all of the shopping cart and revenue data, is the perfect place to “close the loop” on revenue generated by offers. By opening up the payment stream on a purchase that is associated with an offer code, a redemption service can update its related modules and systems to understand how effective various marketing programs have been at driving real revenue.

Distributed Offers system, method and computer program product as described herein provides a party, such as a payments provider or third party independent marketing software vendor, with an environment in which they may create loyalty or promotional campaigns to offer customers transacting with merchants across channels, and closes the loop on reconciling the offer and redemption cycle. Distributed Offers makes use of a secure payment profile tokenization, provides real time purchase/basket data indexed by payment method identifier, and supplies a mechanism for the customer to claim the payment method identifier and link it to a profile identifier. Further, it supplies a mechanism to link an offer code to a profile ID and provides a centralized redemption validation and notification process. Consumers may link multiple payment method identifiers (e.g. Visa, MasterCard, Interac Card, Bitcoin Wallet) to their profile ID. These features enable a party or service to integrate their marketing software to any enabled mPOS merchant, and create rewards and offers based off exact purchase activity of a profile ID. Offers can be linked to a consumer's profile ID and payment method identifier, creating frictionless redemption during payment processing. In addition, redemption notifications are sent directly to both the merchant and the redemption service seamlessly through the network.

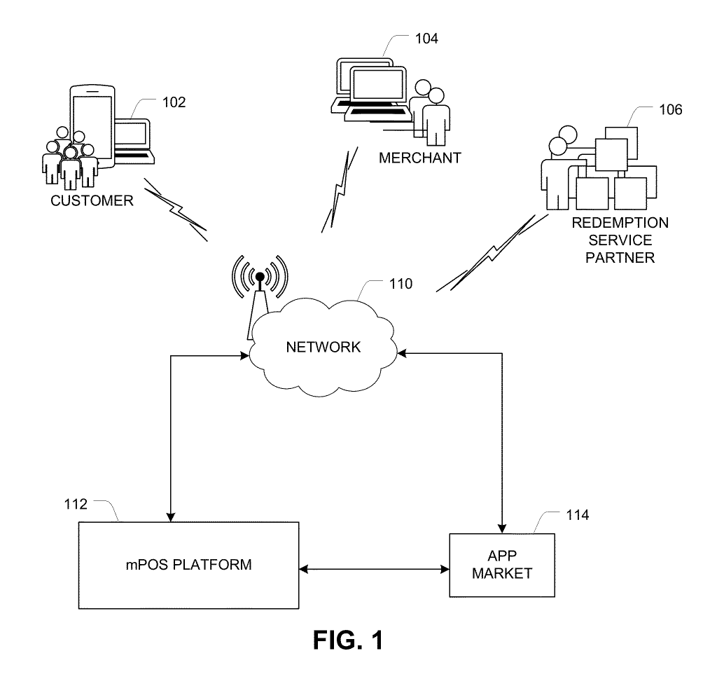

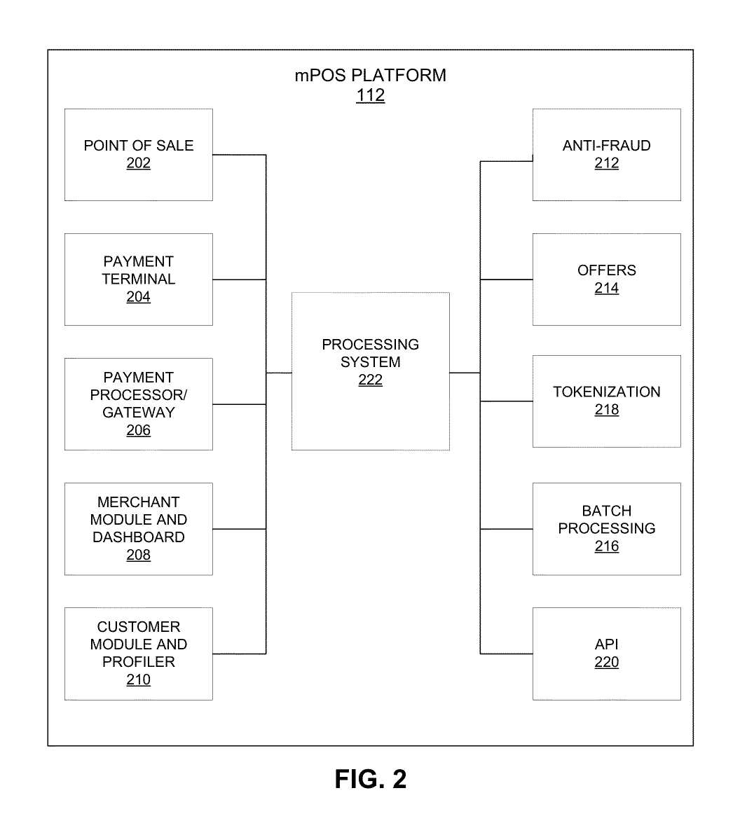

FIG. 1 illustrates an exemplary mobile ecommerce network environment providing payments and loyalty programs for merchant subscribers across channels. An mPOS payment platform 112 provides all services necessary to complete payment transactions at merchant store mPOS terminals or online. A payment platform 112 may comprise a payment gateway, merchant accounts through which payments are processed, payment-type configurations, a secure interface for collecting payment data, and more, as will be described in FIG. 2. The platform 112 may be capable of providing payments systems for at least card-not-present payments made over the internet and a mobile point of sale interface (i.e. payment terminals) for physically collecting payment data in a physical, brick-and-mortar store 104. Additional services may be provided, either by the payment platform 112 itself, or by third parties integrated with the payment platform, such as the redemption services partner 106 illustrated here. While the drawings and disclosure will primarily describe Distributed Offers using a third party redemption service, one of ordinary skill in the art will recognize that those same services may be provided at the payment platform itself, by providing, for example, a module performing the same services.

Referring again to FIG. 1, an application marketplace 114 allows merchants 104 to view and license apps and other functional tools, including loyalty/reward applications for customer devices and widgets to add various functions to web sites. A merchant 104 may have an online presence, a physical presence, or both. As illustrated here, customer 102, merchant 104, and redemption service 106 may communicate with the mPOS 112 in a network-connected environment 110 to provide and receive mobile ecommerce services—including payment transactions, offers and redemptions. The mPOS platform 112 may be implemented or deployed in one system or separate, individual modules across distributed systems.

FIG. 2 provides a general abstraction of the mPOS platform 112 and its services. This diagram and the services it depicts are offered as an illustration of an mPOS platform 112, however, the mPOS platform 112 is not limited to providing only these services in this particular manner. The platform 112, by way of illustration and not limitation, may comprise a point of sale module 202, a payment terminal module 204, payment processor and gateway systems module 206, a merchant module with dashboard 208, a customer module and profiler 210, a fraud module 212, an offers module 214, a batch processing module 216, a tokenization module 218 and an API module 220. As is well-known by those of skill in the art, a module describes a unit of functionality that can be used to construct a more complex structure. Modules of a computer system may comprise hardware, software, or a combination of the two. Software modules may contain program code or instructions stored in memory for controlling a computer processor to perform a particular method to implement the features or operations of the system. A processing unit 222 carries out the instructions of the various modules to realize the features of the claimed system, method and computer products.

A point of sale module 202 facilitates operations related to the sale of an item, such as adding items to a cart or executing payment. A payment terminal module 204 supports a device interfacing with payment cards to collect information stored on the card. A payment processor and gateway systems module 206 processes the payment transaction from the data collected at the payment terminal 204. A merchant module with dashboard 208 allows merchants to create an account and register for services. A customer module and profiler 210 holds customer information such as customer information, tokenized payment details and more. A fraud module 212 performs fraud detection operations on payment transactions to minimize or prevent fraud.

An offers module 214 within a payment platform 112 system may support the promotion, co-promotion, loyalty and gift card redemption features provided by the system, method and computer program product described herein. An offers module 214 further provides services for creating offers composed of variables that can be applied to a transaction or account. Collectively, the variables may be identified as a “coupon” and may include: a redemption code that identifies the discount or adjustment to a transaction; a merchant ID; a location id representing the store location, for situations where a merchant has multiple store locations; merchant information, such as name, telephone, address, etc; an inventory listing of the merchants products; a creator ID representing the third party partner or owner of the offer; a Boolean identifier indicating whether the offer code is a single use code; start and end dates for the offer; currency to which the offer may apply; the name and description of the offer; and coupon types, which may be applied in various ways, such as applied to a particular item (i.e. SKU) or applied to any item purchase in the store. Additional features of the offers module 216 are described below in reference to cross promotions, purchase tracking and refunds.

Considering FIG. 2 further, a batch processing module 216 may be included to receive data files, via FTP for example, for operations that do not require, or are not available for, real-time processing. A tokenization module 218 provides the technology for tokenizing payment details in order to provide PCI compliance, by substituting a sensitive data element (payment method) with a non-sensitive equivalent (the token), to provide a unique customer ID which links transactions and payment methods to a particular customer. Tokenization may be accomplished through any of the many secure methods for encrypting data. Distributed Offers uses security best practices to ensure that sensitive data is protected.

Finally, the API module 220 provides application programming interfaces (APIs) for communications and transferring data between modules to perform the methods described herein. As is well known in the art, APIs include routines, protocols and tools for building software applications and for specifying how modules should interact. Additional APIs may be included to perform back office functions, such as chargeback processing, batch file uploads, recurring billing processes, etc.

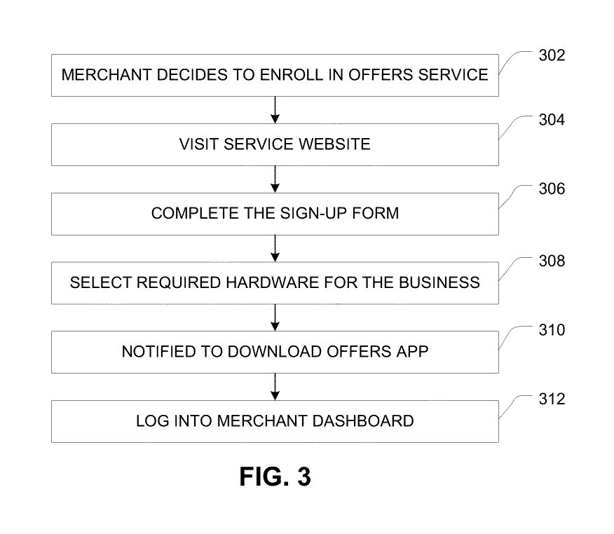

Distributed Offers allows a merchant to create an offer/loyalty program by enrolling in an offers service. One of ordinary skill in the art will recognize that offers services may be provided by the payment provider or by a third party application developer, or others, as described herein. The merchant, typically a retail store which may have either a physical and/or an online presence, may enroll in offer services by creating an account with the marketing offers system or module. An example of this process is illustrated in FIG. 3. A merchant decides to enroll in the offers service 302, and visits the services website 304. The merchant completes the enrollment form 306 and selects the hardware applicable to its business 308. The merchant receives a notification to download a Distributed Offers app 310. A Distributed Offers app provides an interface for configuring campaigns, tracking customer offers and redemptions through notifications received from the mPOS system APIs as such offer/redemption transactions occur, and other services. Notifications may be synchronous or asynchronous. The app may further provide reports that allow the merchant to monitor the effectiveness of its marketing campaigns. Once the app is downloaded, the merchant may log in 312 to begin using the services.

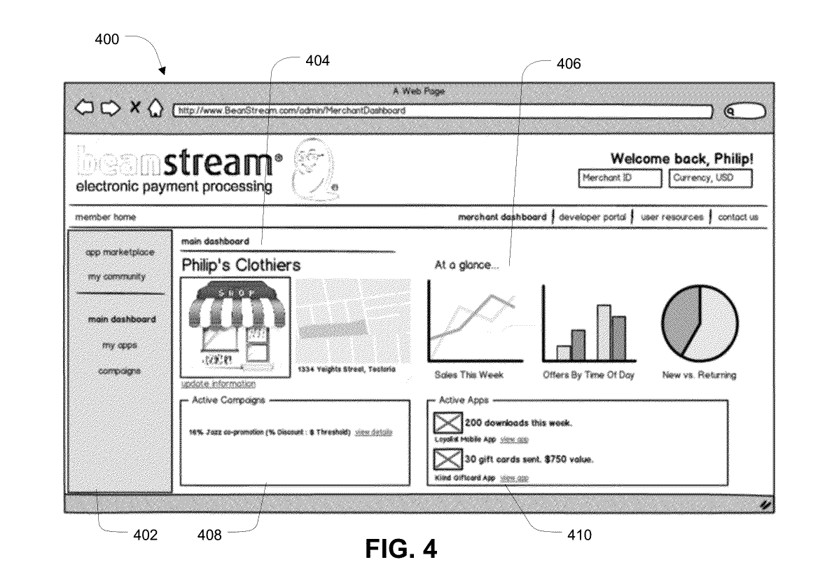

A Distributed Offers merchant interface 400 comprises a system dashboard that allows the merchant to create and manage promotional campaigns across merchants, payment types and channels. FIG. 4 provides an exemplary illustration of a service website interface and dashboard 400. A merchant dashboard works like a control center for enrolled merchants. The dashboard may provide several sections or components, supported by payment platform modules, to manage offers and promotional campaigns. Offered by way of example and not limitation, a dashboard may include several components listed on a menu bar, as is illustrated at 402. In this example, components may include an “app market place” allowing the merchant to order loyalty apps and other features, a “my community” component for generating shared promotions with other merchants, a “my apps” component for app maintenance, a “campaigns” component for provisioning promotional offers. Not shown here, might also be a “customer” component to manage customer information and a ‘message center’ component to send or receive email or messages. The ‘main dashboard’ component 404 may present the merchant with an overview of the active campaigns subscribed to 408, the app activity for merchant campaigns 410 and statistics 406 for sales and offers. Further functionality included in the various sections will become apparent as the system and methods are described below.

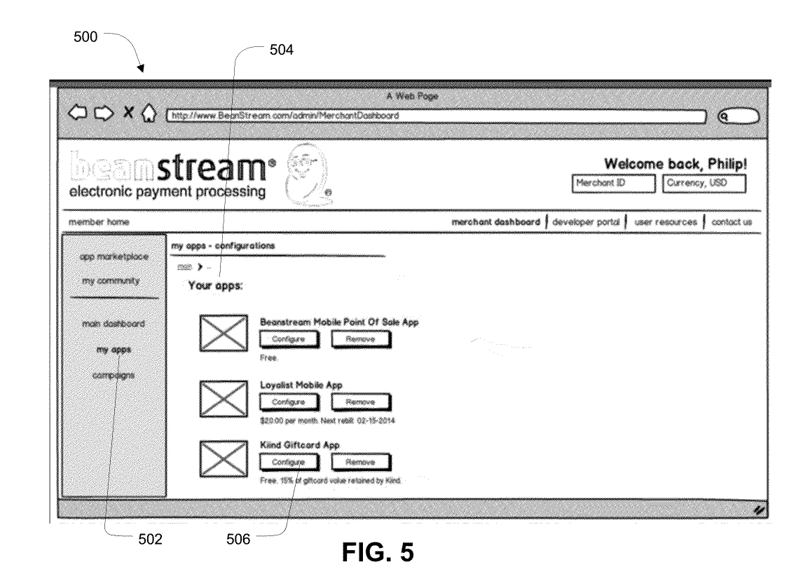

App development partners such as a marketing application partner offering redemption services 106 may contribute loyalty redemption, sales and marketing apps to the mPOS app marketplace, providing beneficial services for both the merchant 104 and customer 102. In addition to loyalty program apps, others may be available, such as gift certificate apps, widgets that may be added to the customer's web store, and other payment-related features. For example, development partners 106 may create a loyalty redemption service application that customers 102 may download to their mobile device allowing them to track purchases and redeem, or receive redemption notification of, promotional campaigns created by merchants 104 with whom they have done business. For example, a customer app may show the customer that a free coffee at a neighboring coffee shop is available as a result of his purchase of a particular item on a cross-promotional offer. The application may leverage a set of standard APIs integrated with the mPOS 112 and the merchant dashboard interface 200 to implement redemption-as-a-service through the same platform or terminal that manages the merchant's 104 payment methods. The merchant 104 may view a number of loyalty apps in the app marketplace component, review licensing requirements, and purchase. Licensed apps are then made available for configuration and management in the ‘my app’ component 204. FIG. 5 provides an exemplary user interface 500 for a ‘my app’ component.

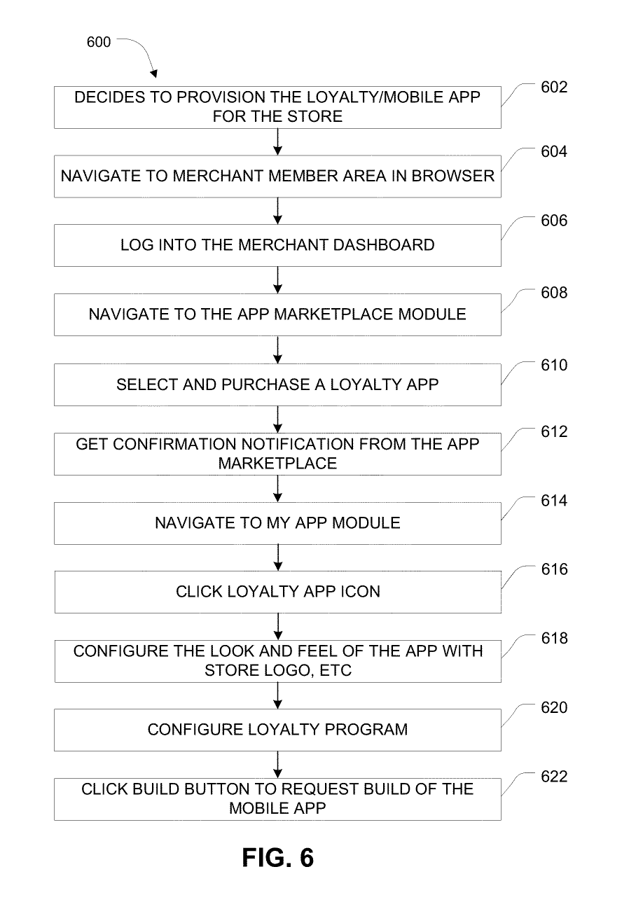

As a general example used in some embodiments, the merchant 104 may use a ‘my app’ component 502 to view all the apps selected for the merchant's business, and may configure the loyalty app 504 that will be offered to his customers by clicking on the ‘configure’ button 506 next to the desired app. Refer also to FIG. 6, which illustrates the process of creating and configuring a loyalty app 600. The merchant 104 leveraging the mPOS payment system first decides to provision a loyalty app for his business 602. The merchant 104 logs into the Member Area on the service web site as discussed above with reference to FIG. 2. After logging in, he may navigate to a Merchant Dashboard 400, 606. Clicking the App Marketplace icon on the menu bar 602 provides access the App Marketplace section 608. The merchant 104 may select and purchases an available loyalty app 610. The purchase may be confirmed by a notification that may come through the Dashboard's message section 612, and the merchant 104 finds the configurable app in the my app 502 component 614. Upon clicking on the loyalty app icon, the merchant 104 may configure the look and feel of the app, add a logo, hours of operation, etc. 618, and configure one or more loyalty programs 620.

In some embodiments, once the merchant 104 has completed the configurations, he may tap a ‘Build My App’ button 622 which kicks off a process flow with the redemption services partner or module 106 creating the app. The partner 106 generates the binary, submits it to the app marketplace owner, who then notifies the merchant 104 when his store's unique and customized app is live in an App Store, such as the Apple® or Apps for Windows®. Once his app is live in the App Store, if minor aspects, such as hours or highlighted inventory, require change, he can do this automatically without the partner's 106 involvement. Once the app is live in the App Store, the merchant 104 may receive a package from the partner via the dashboard's message center, and an email explaining best practices for promoting the mobile app to his customer 102 base and details on the redemption process using the mPOS functionality. Subsequent campaign configurations merely require that the merchant tap an “activate campaign” button. At this point the merchant 104 may send an email to his subscribers 102 promoting the loyalty program with a link to the app. One of ordinary skill in the art will recognize that this is one way in which to create an application that is capable of monitoring, tracking and updating information provided to it by a payment platform API, and that other systems and methods may be used for this same or related purpose.

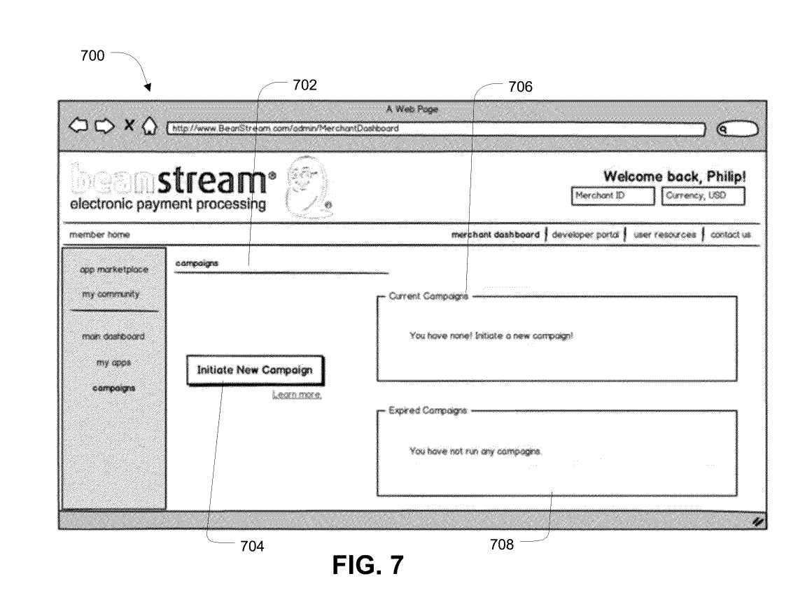

A merchant may create promotional campaigns using a campaign component interface 700, an example of which is illustrated in FIG. 7. A campaign interface 702 allows the user to initiate a new campaign 704, and view and select both new 706 and expired 708 campaigns. By clicking an “Initiate New Campaign” button, the merchant may be offered a New Campaign Setup interface, such as the one illustrated in FIG. 8. The campaign component of a Distributed Offers system, method and computer program product allows the merchant to set up and configure promotional campaigns and loyalty programs, for which customers 102 may track and redeem using any connected and authorized app or service.

Loyalty programs may take many forms. For example, a merchant 104 may set a dollar threshold that gives the customer 102 a percentage discount when the customer 102 spends the threshold amount during a particular time period (e.g. if the customer 102 spends $250 in the store in one month, they get a 25% discount on their next purchase, and it must be redeemed by the end of the year.) Another exemplary campaign is a mobile notification campaign for which the merchant 104 may select various groups, or all subscribers 102, to whom notifications, such as sales notifications, may be sent. In addition, merchants 104 may set up a co-promotional campaign with other merchants 104 it has identified in its community component. For example, a yoga studio located across the street from a coffee shop might create a coupon code applicable for a reward at the coffee shop for doing some measure of business at the yoga studio, or vice versa.

Referring again to FIG. 8, a campaigns component allows the merchant to set up a new campaign 802. The merchant may select a type of campaign 804, such as a co-promotional event or a mobile notification event, for example. For a co-promotional campaign, the merchant may request a partner 806 from his community of partners, which will be discussed further below. The merchant chooses a promotion type 808 and sets the promotion parameters 810. As was discussed above, promotion parameters may include dollar amounts, discount percentages, and the like.

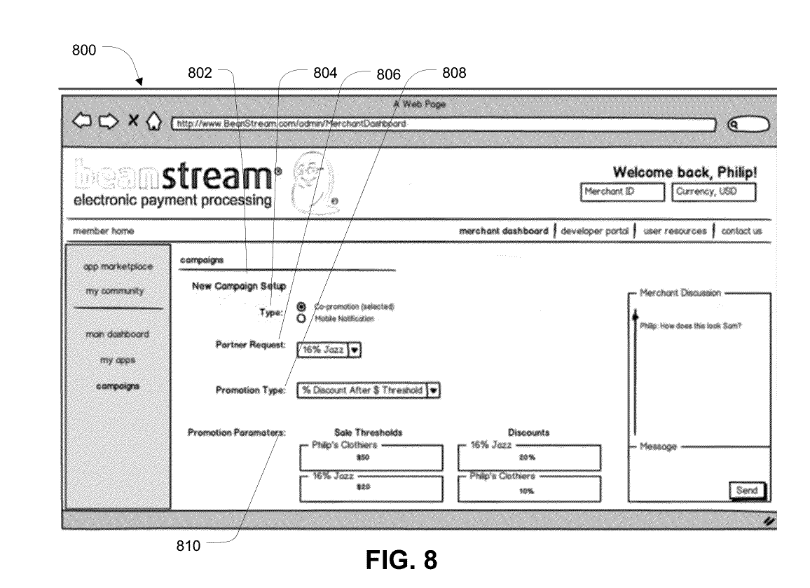

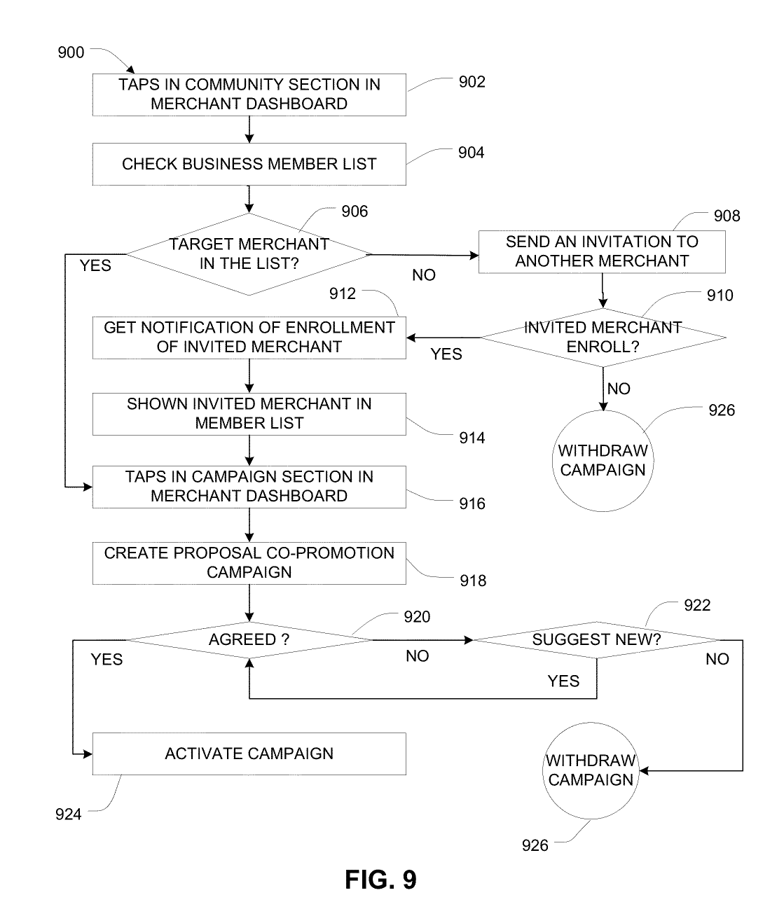

Merchants 104 may negotiate the terms of a co-promotion through the dashboard 900. As is illustrated in FIG. 9, a first merchant 104 may navigate to the community component 902 and access a list of merchants subscribing to Distributed Offers 112, 904. If the target merchant is on the list, the merchant may access the campaign module 906 and create a proposal for a co-promotional campaign 908. If both merchants agree on the terms of the campaign they may activate the campaign 924. If they don't agree, they can propose different campaigns, negotiating the terms until they agree, or determine that they should withdraw the campaign. If the target merchant is not on the subscriber list 906, an invitation to enroll may be sent to the target merchant 908. If the invited merchant enrolls 910 a notification is sent to the first merchant 912 and the first merchant may now find the invited (target) merchant on the list 914. Otherwise, if the invited merchant does not enroll the co-campaign is withdrawn.

Once the app is live with a merchant 104, and campaigns have been setup and configured, the app tracks purchases for customers 102 even if the customer 102 hasn't enrolled in the program. When the customer swipes her card to make her first purchase on the mPOS system 112, her payment method details are tokenized and associated with a dynamically created customer profile id which is provided to the customer on a receipt or thank you page. In this way, customer purchases may be tracked by payment method. In order to comply with privacy laws, the credit card number itself is not used for identification. Rather, transactions are tracked against tokenized payment details for customers 102, even if the customer 102 isn't enrolled in the program. The token created from the payment details (e.g. payment card number and type) is stored in the system 112 and is associated with a dynamically generated profile ID. The payment information itself may, in some embodiments, be stored in the payment system along with the token. In others, payment details may be stored in a secure profile system. The profile ID, which could be called a passcode, unique ID or a Customer ID, is provided to the customer 102 as a printed code on the paper receipt or in a confirming text message, email or web store thank you page for online purchases. The customer 102 interested in participating in a rewards program may use the code to claim the profile by downloading and accessing the loyalty app licensed and configured by the merchant 104 in the app store. The customer's 102 app profile allows her to add additional payment, shipping, promotion and preference data, which may be used to speed up checkout in subsequent on- or offline transactions. Further, the profile is continually updated with purchase information as the customer 102 shops, online or offline, at this merchant or others utilizing the mPOS platform 112 using APIs which connect all qualifying activity in mPOS 112 to the app and the customer. All transactions made with the customer's payment types are linked through the customer profile. The system tracks purchases and associates them with the same tokenized payment details across merchants. Once the customer has linked more cards to the mPOS system 112, through one or more customized store apps, and claims their profile, the system will track purchases and rewards across payment methods and merchants for all merchants who are using the mPOS system. Once activated, the app may alert the customer 102 to sales and other merchant 104 announcements. The customer 102 may eventually supply additional payment method details in the app, which may be used to streamline the loyalty tracking and redemption process. All payment methods may be tokenized and associated with the profile so that payment by any method in the profile allows the system to automatically unlock and apply the reward.

As was described above, Distributed Offers tracks transactions even if the customer 102 has not downloaded the loyalty app or enrolled in the service. As the customer 102 creates new transactions, such as making payment transactions and receiving and redeeming offers, the mPOS 114 reconciles the loyalty rewards for each campaign. When the transactions satisfy the requirements of the campaign, the reward is unlocked and ready to use and will automatically be applied without the customer having to provide a coupon, code or other information.

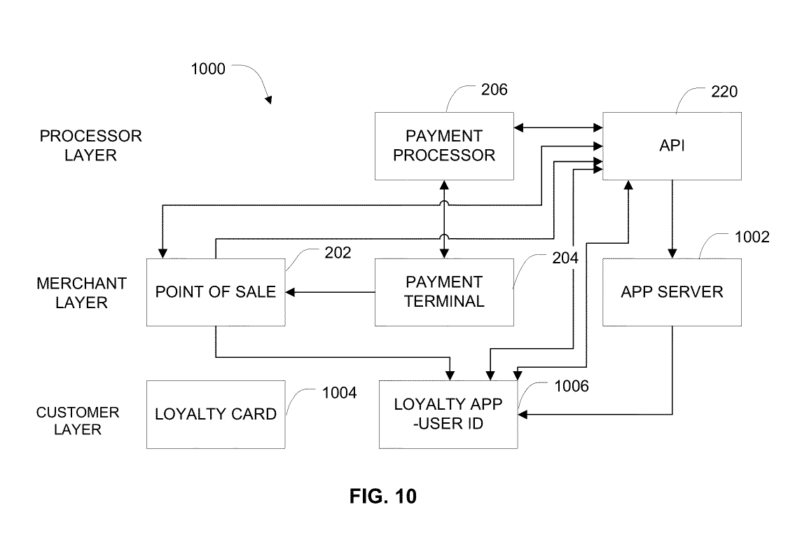

FIG. 10 provides a diagram illustrating possible interactions required for an optional loyalty app accessed via point of sale transactions at a physical location. In some embodiments, these interactions can be depicted as occurring in three layers—a processor layer, a merchant's layer and a customer layer. The processor layer includes the payment processor 206 and the API module 220. The merchant layer comprises the point of sale module 202, the payment terminal 204, and through all APIs, the App Server 1002. Interactions at the customer layer comprise a virtual Loyalty “card” 1004 (representing enrollment of the customer in the loyalty program) and a Loyalty App 1006. The modules might interact at least in three basic scenarios defined by the customer's enrollment: (1) before the customer has associated the app with a payment method, (2) when the customer associates the app with the payment method and (3) after the customer associates the app with the payment method.

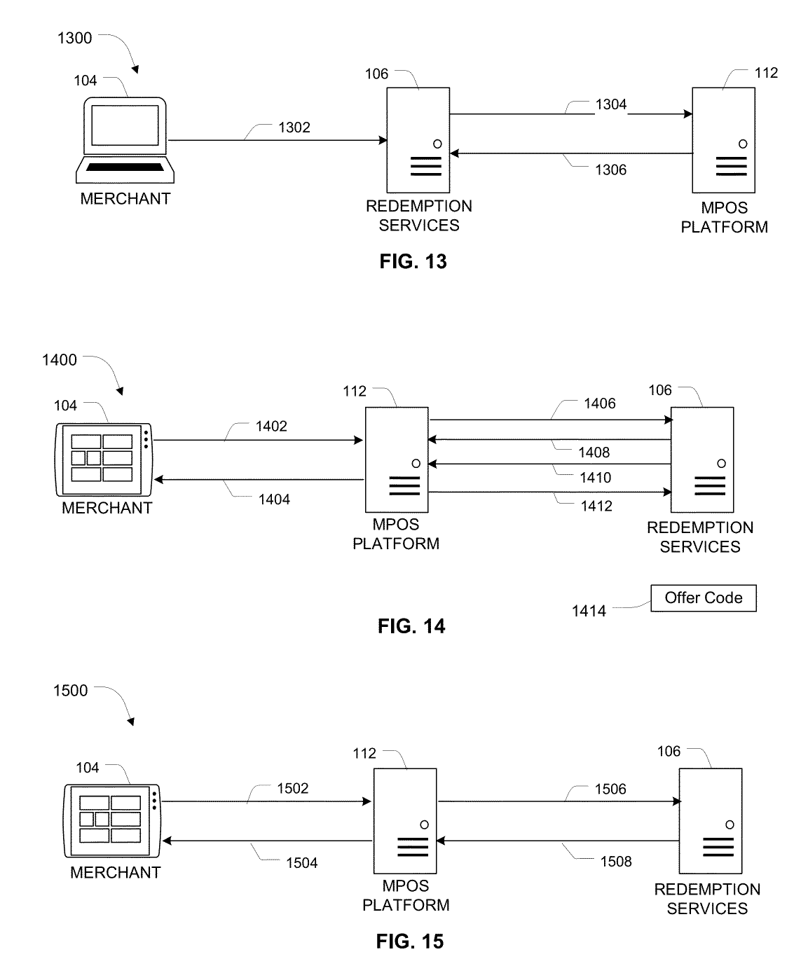

In the first scenario, interaction is initiated when the customer decides to purchase items and the merchant enters the items into the payment terminal, which communicates with the POS system 202. The POS requests an unused code from the API. When the customer pays, a receipt is issued with a printed code. The payment terminal informs POS of the transaction ID, and the POS informs the API that a transaction occurred with the transaction ID, SKUs, and the printed or displayed offer code. The API requests a user identifier for the transaction and associates and stores the customer, items purchased and offer code. In the second scenario, the customer has a receipt with the printed offer code, downloads the loyalty app and enters the code. The loyalty app requests a user id for the given printed code and stores the user id with the code. The loyalty app requests a list of all unredeemed rewards that match the user ID and the shop and displays those rewards in the customer's loyalty app. In the third scenario, the customer has the loyalty app and has payment methods associated with it. The customer purchases items and the cashier enters the items into the POS. The POS requests a new offer code from the API. The customer pays and a receipt is issued with the new offer code. The payment terminal informs POS of the transaction ID, and the POS informs the API that a transaction occurred with the transaction ID, SKUs, and the printed offer code. The POS requests a user identifier for the transaction. The API stores the customer, card data including purchased items and code and sends the app server the customer and item information to the app. The app server may push a notification to the user's device. When the user opens the app, the loyalty app requests and displays a list of all unredeemed rewards that match the user ID and the merchant. Customer rewards are automatically redeemed as the payment method being used is tokenized and matched with the customer profile. Notifications may then be sent to the customer and the merchant to update each profile campaign. Campaigns are reconciled through API notifications as described in FIGS. 13-15.

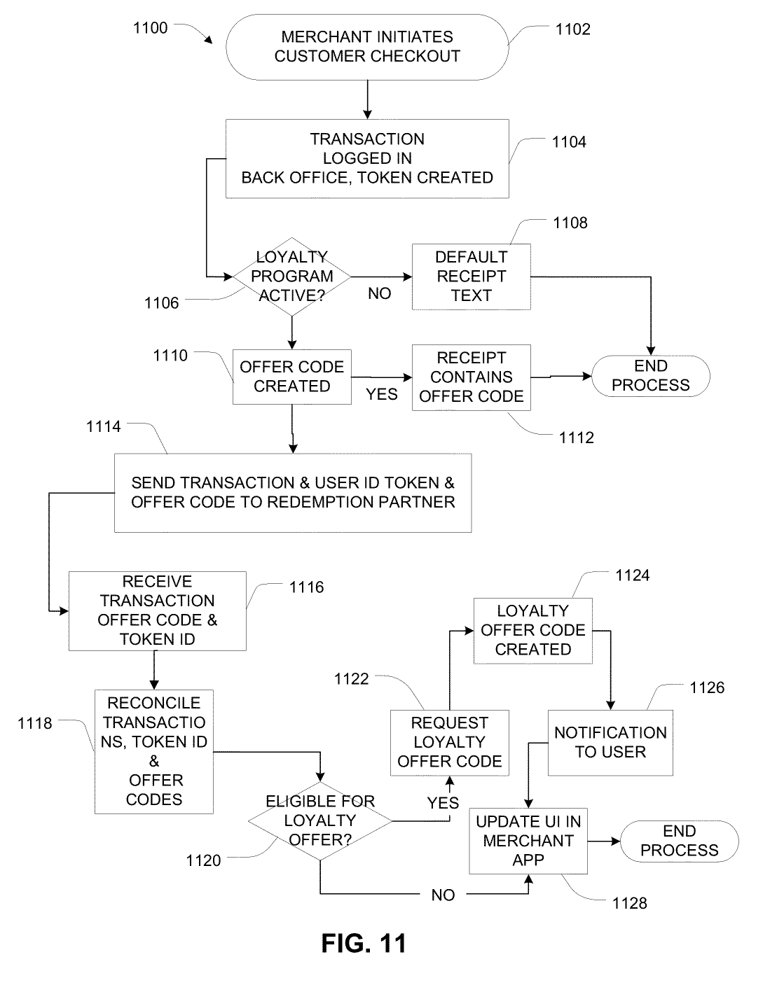

FIG. 11 illustrates, for one embodiment, the accumulation of loyalty rewards as the customer purchases eligible products with enrolled merchants. The process begins when a merchant initiates the customer checkout process 1102. The transaction is logged in back office 1104 and the payment method may be tokenized. The system checks for active loyalty programs related to the merchant 1106. If there are no active programs the receipt is created with default receipt text 1108. If there is an active program, an offer code is created 1110 and printed on the receipt 1112. After the offer code is created, transaction data is sent along with the user id token and offer code 1114 to the redemption service, which receives the transaction data 1116. The redemption service reconciles transactions, code IDs and offer codes 1118. If the customer is eligible for the offer 1120, the redemption service makes a request for a loyalty offer code 1122, the code is created 1124 and the user is notified 1126. The user's offer application is updated accordingly 1128, with the changes reflected in the user interface (UI). If the transaction isn't eligible for a loyalty offer 1120, that information is also updated in the UI 1128.

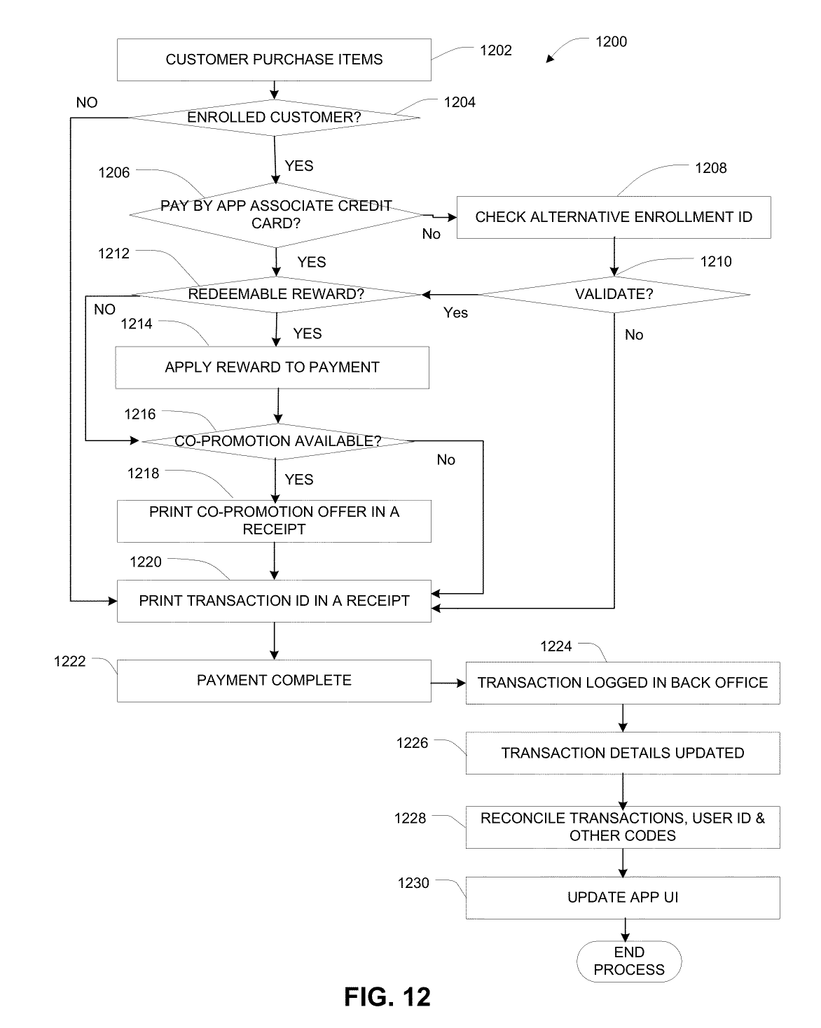

FIG. 12 provides an exemplary flow of a customer purchase and reward redemption. When a merchant completes a purchase transaction 1202, the enrolled customer 1204 at a physical store need only tap her credit card on the payment terminal, or select the payment method if transacting online. If the credit card is associated with a loyalty program 1206, the discount will be automatically applied to her total. A notification window may appear on the mPOS 112 screen indicating that this credit card has a valid discount offer attached to it 1212. The customer 102 may use an alternative pay-type associated with the enrolled customer ID 1208 and validated 1210. Then the merchant simply taps “apply discount” on the notification window 1214 and the reward is applied to the order total. The customer completes her payment and receives her receipt. If the merchant has a co-promotion campaign available 1216, an offer code is printed on the bottom of the receipt 1218 as well as a transaction ID 1220. The customer's mobile device may also notify her that she has a new promotion in “offers from our friends” from the other merchant. The customer may claim her offers with either the receipt or with her mobile device. The purchase is completed 1222, with all accounting and reconciliation of promotional offers seamlessly completed between the mPOS 112 and the redemption services partner 106. These back office functions may include logging the transaction 1224, updating transaction details 1226, reconciling transactions 1228, user ID and other codes, and updating the app UI to reflect the transactions 1230.

FIGS. 13-15 illustrate the communication among merchants 104, the mPOS platform 112 and, in some embodiments, a marketing partner offering redemption services 106 (or redemption services partner), as offers are set up, purchases are made and loyalty rewards are redeemed. One of ordinary skill in the art will understand that the system leverages a set of application programming interfaces (APIs) to communicate these transactions. As was illustrated in FIG. 8, a merchant creates a loyalty offer campaign in the mPOS dashboard. When the merchant is finished and taps the create button, the campaign API 1302 is directed to the redemption services partner, as is illustrated in FIG. 13. The redemption services partner initiates another API 1304 to update a campaign flag in the POS payment system. The POS updates the campaign flag and returns an acknowledgment 1306. A receipt code is created in mPOS 112 that may be appended to the receipt if the merchant 104 has created a campaign. A receipt could mean a physical paper receipt if the transaction is performed in a physical store, a text message if the transaction is performed on a communications device with text messaging, or an on-screen, thank-you page receipt if the transaction is performed online.

FIG. 14 illustrates a set of purchase transactions. The use of a customer's 102 mobile device to make a purchase was described above. The merchant 104 initiates the customer checkout process on the mPOS platform 112 or web page by sending a purchase request API 1402. In addition to completing the payment transaction, the mPOS 112 determines if a campaign has been created by the merchant 104. If the merchant has created a campaign, a receipt code will be generated and transmitted 1404 to be appended to the receipt. The transaction details (e.g. receipt code, merchant ID, items purchased, and the tokenized id for the payment card) are sent to development/redemption services 1406, which acknowledges receipt of the data 1408. The development/redemption services 106 tracks item purchases and if the customer 102 is eligible for a loyalty offer a request for an offer code is issued 1410 to the mPOS 112, and the code is returned 1412 to and stored 1414 in the development/redemption services module.

Referring now to FIG. 15, the customer 102 may redeem their reward at checkout using their offer code. A customer 102 making a physical purchase presents the merchant 104 with an offer code that she has received on her receipt or mobile device store app. The merchant 104 initiates the checkout process on the mPOS 112 as described above. A valid offer code is sent 1502 to the mPOS 112, which adjusts the transaction price to meet the offer and returns 1504 this information to the merchant 104 along with the payment transaction details. The mPOS 112 sends 1506 the redeemed offer information (e.g. merchant id and offer code) to the development/redemption services 106 which updates the status of the offer to redeemed. The development/redemption services send 1508 an acknowledgment to the mPOS 112 indicating that the status change is complete. The same process may be triggered during online checkout flow by association with the payment method, or by using a PIN, phone number, email address and/or password or any such combination.

Because the rewards system, which has completely reconciled the offers/rewards is integrated with the mPOS, the system provides a great deal of information for a marketer to manage his business. Further, the mPOS 112 dashboard customer component may contain extensive customer relationship management features that provide the merchant with reporting and analytics. In this module, he can view data and statistics such as how many loyalty app installs he has, revenues for a particular time period, and other information, such as that measures the success of his promotional campaigns. In addition, he can determine which of his customers are new, and can segment his customers over time.

As was described above, there may be various embodiments of the disclosed system and methods. In some embodiments, transactions are performed in physical stores with the card present and in others the transactions are performed online, card not present. Similar features, such as configuration, process, and API flows apply to purchases made via mobile device and online. In addition, some embodiments may include storing customer payment data in the mPOS so that customers may use the system to provide payment for a transaction, in person or online. In some embodiments, the customer data is stored in a secure profile in the mPOS, while in others it is stored at an acquiring bank through which payment is made. In all cases, storage of sensitive data is PCI compliant.

It will be appreciated by those of ordinary skill in the art that the described embodiments may be realized as a system, method, computer program product, or a combination of the three. The disclosed embodiments may take the form of an entirely hardware embodiment, an entirely software embodiment, or a combination of hardware and software. The embodiments may also take the form of a computer program product on a non-transitory computer-readable medium having computer-usable program code encoded thereon.

The various components of the system may be hosted on servers in a cloud environment.

Servers may be accessed by networked (e.g. internet) users through an application or mobile app on a remote computing device. The mPOS platform generally comprises application programming interfaces, a commerce engine, services and third party services and solutions. The application programming interfaces may include tools that are presented to a user for use in implementing and administering online stores and their functions, including, but not limited to, store building and set up, merchandising and product catalog (user is a store administrator or online merchant), or for purchasing items from an online store (user is a shopper). For example, end users may access the ecommerce system from a computer workstation or server, a desktop or laptop computer, a mobile device, or other electronic telecommunications or computing device. A commerce engine comprises a number of components required for online shopping, for example, customer accounts, orders, catalog, merchandizing, subscriptions, tax, payments, fraud, administration and reporting, credit processing, inventory and fulfillment. Services support the commerce engine and comprise one or more of the following: fraud, payments, and enterprise foundation services (social stream, wishlist, saved cart, entity, security, throttle and more). Third party services and solutions may be contracted with to provide specific services, such as address validation, payment providers, tax and financials. Merchant integrations may be comprised of merchant external systems (customer relationship management, financials, etc), sales feeds and reports and catalog and product feeds. Partner integrations may include fulfillment partners, merchant fulfillment systems, and warehouse and logistics providers. Any or all of these components may be used to support the various features of the disclosed system and method.

An electronic computing or telecommunications device, such as a laptop, tablet computer, smartphone, or other mobile computing device typically includes, among other things, a processor (central processing unit, or CPU), memory, a graphics chip, a secondary storage device, input and output devices, and possibly a display device, all of which may be interconnected using a system bus. Input and output may be manually performed on sub-components of the computer or device system such as a keyboard or disk drive, but may also be electronic communications between devices connected by a network, such as a wide area network (e.g. the Internet) or a local area network. The memory may include random access memory (RAM) or similar types of memory. Other examples include a portable computer diskette, a hard disk, a read-only memory (ROM), an erasable programmable read-only memory (EPROM) or flash memory, a portable compact disc read-only memory (CD-ROM), an optical storage device, or a magnetic storage device. Any non-transitory computer-usable or computer-readable storage medium may be utilized. The computer-usable or computer-readable storage medium may be, for example, but is not limited to, an electronic, magnetic, optical, electromagnetic, infrared, or semi-conductor system, apparatus, or device, but does not include a signal per se nor any other transitory media. In the context of this document, a non-transitory computer-usable or computer-readable storage medium may be any non-transitory medium that can contain or store a program for use by or in connection with an instruction execution system, apparatus, or device.

The disclosed embodiments may take the form of a computer program product on a non-transitory computer-readable medium having computer-usable program code encoded thereon. Computer executable instructions, or software applications, stored in the memory or secondary storage for execution by a processor are operatively configured to perform the operations in an embodiment of the system. These computer instructions may be stored in a computer-readable memory, as described above, that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may be loaded onto a computer or other programmable data processing apparatus to cause a series of operational steps to be performed on the computer or other programmable apparatus to produce a computer-implemented process, such that the instructions which execute on the computer or other programmable apparatus provide steps for implementing the functions/acts specified herein described in text or as specified in a flowchart and/or block diagram block or blocks. Alternatively, computer program implemented steps or acts may be combined with operator or human implemented steps or acts in order to carry out an embodiment of the invention. As used herein, the term “coupled” includes both a direct electrical connection between blocks or components and an indirect electrical connection between blocks or components achieved using intervening blocks or components.

Software applications or computer-executable instructions, may correspond with a single module or any number of modules. Modules of a computer system may be made from hardware, software, or a combination of the two. Generally, software modules are program code or instructions for controlling a computer processor to perform a particular method to implement the features or operations of the system. The modules may also be implemented using program products or a combination of software and specialized hardware components. In addition, the modules may be executed on multiple processors for processing a large number of transactions, if necessary or desired. Where performance is impacted, additional processing power may be provisioned quickly to support computing needs. The processor may execute the software applications or programs either stored in memory or secondary storage or received from the Internet or other network.

Furthermore, it should be recognized that computational resources can be distributed, and computing devices can be distributed over all participants in the system. Merchant computers and devices (e.g.) are those used by merchants to access information from a server over a network, such as the Internet. These devices can be a desktop PC or laptop computer, a standalone desktop, smart phone, smart TV, or any other type of computing device. Servers are understood to be those computing devices that provide services to other machines, and can be (but are not required to be) dedicated to hosting applications or content to be accessed by any number of merchant computers. Web servers, application servers and data storage servers may be hosted on the same or different machines. They may be located together or be distributed across locations. Operations may be performed from a single computing device or distributed across geographically or logically diverse locations.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. For example, the present techniques can be implemented in any kind of system that includes a hard disk drive. The embodiment was chosen and described in order to best explain the principles of the invention and the practical application and to enable others of ordinary skill in the art to understand the invention for various embodiments with various modifications as are suited to the particular use contemplated.

What is claimed is:

1. A system for providing offers and redemption services, the system comprising:
a memory device with computer-readable program code stored thereon;
a communication device;
a processing device operatively coupled to the memory device and the communication device, wherein the processing device is configured to execute the computer readable program code to:
receive a merchant opt-in for access to an offer and redemption service, wherein access allows the merchant to (i) configure marketing campaigns as offers to a customer at a merchant store or website wherein the campaign is defined for a product or service, (ii) identify as a member of a merchant network and (iii) allow the merchant to locate a second merchant who is a member of the merchant's network and propose and activate a co-promotional campaign;
receive a merchant opt-in granting access for a third party application provider, wherein access allows the third party application provider to access purchase details associated with tokenized payment details for the purposes of operating marketing programs based off customer purchase behavior; request offer codes of the system; and to display offer codes to shared customers when marketing program criteria are met.
receive a payment transaction comprising customer and payment details, including payment type and identifier, wherein the payment transaction is the result of a customer purchase at the merchant store or web site and (i) generate a token id from the customer's payment method, (ii) determine the eligible offers available for the transaction based on the transaction details and (iii) associate the offer with the token id.

2. The system of claim 1 wherein the processing device is further configured to execute the computer readable program code to:
match the token id created from the customer's payment method to activated promotional campaigns to locate offers available to the customer;
automatically redeem eligible campaign offers based on the token id created from the customer's payment method; and
record the offer and redemption details by token id created from the customer's payment method, the record comprising at least (1) purchase and cart data and (2) revenue.

3. A computer program product for providing marketing offer and redemption services to customers of merchant stores, the computer program product comprising a non-transitory computer readable medium having computer readable program instructions stored therein, wherein said computer readable program instructions comprise:
instructions configured to receive a merchant opt-in for access to a marketing offer and redemption service, wherein access allows the merchant to (i) identify as a member of a merchant network and (ii) configure marketing campaigns as offers to a customer at a merchant store or website wherein the campaign is defined for a product or service and (iii) allow the merchant to locate a second merchant who is a member of the merchant's network and propose and activate a co-promotional campaign;
instructions configured to receive a payment transaction comprising customer and payment details, including payment type and identifier, wherein the payment transaction is the result of a customer purchase at the merchant store or web site and (i) generate a token id from the customer's payment method, (ii) determine the eligible offers available for the transaction based on the transaction details and (iii) associating the offer with the token id.

4. A computer program product for providing loyalty offer and redemption services to customers of merchant stores, the computer program product comprising a non-transitory computer readable medium having computer readable program instructions stored therein, wherein said computer readable program instructions comprise:
instructions configured to receive a subsequent payment transaction identified by the token id created from the customer's payment method wherein the payment transaction is the result of a customer purchase at (i) the first merchant store or website or (ii) a second merchant store or website associated with the first merchant store and a co-promotional campaign;
instructions configured to match the token id created from the customer's payment method to activated promotional campaigns to locate available offers;
instructions configured to automatically redeem eligible campaign offers based on the token id created from the customer's payment method; and
instructions configured to record the offer and redemption details by token id created from the customer's payment method, the record comprising (1) purchase and cart data and (2) revenue .

5. A computer-implemented method for providing loyalty offers and reward redemption, the method comprising:
providing a computing system comprising a computing processing device and a non-transitory computer readable medium, where the computer readable medium comprises configured computer program instruction code, such that when said instruction code is operated by said computer processing device, said computer processing device performs the following operations:
receiving a merchant opt-in for access to a loyalty offer and redemption service, wherein access allows the merchant to (i) identify as a member of a merchant network and (ii) configure loyalty campaigns as offers to a customer at a merchant store or website;
receiving a payment transaction comprising customer and payment details, wherein the payment transaction is the result of a customer purchase at the merchant store or web site;
generating a customer profile based on the customer's payment information, wherein creation of the customer profile includes generation of a tokenized version of the received payment method;
providing the generated unique identifier to the customer;
receiving, from the customer, an enrollment request containing the unique identifier comprising the tokenized version of the received payment method, such that the customer is enrolled in the loyalty offer and redemption service;
identifying and providing merchant offers available to the customer, the offers linked to the tokenized payment method unique identifier;
automatically redeeming the offer at the point of sale; and
sending real time notifications to the merchant and the redemption service that the offer has been redeemed including transactional details comprising the customer's payment method token id, purchase and cart data and revenue.

6. The computer-implemented method of claim 5, further comprising:
receiving additional payment transactions for the customer, wherein the payment transactions are the result of purchases from the same or a different merchant;
linking the new payment methods to the customer account.

7. The computer-implemented method of claim 6, whereby the additional payment methods provided are tokenized and associated with the customer and added to the customer profile whereby the additional payment methods are associated with the original tokenized payment method identifying the account.
